(19) United States
(12) Patent Application Publication
(10) Pub. No.: US 2013/0219394 A1
(43) Pub. Date: Aug. 22, 2013

(54) SYSTEM AND METHOD FOR A MAP FLOW WORKER

(71) Applicants: Kenneth Jerome GOLDMAN, Palo Alto, CA (US); Rune DAHL, Mountain View, CA (US); Jeremy Scott HURWITZ, Mountain View, CA (US)

(72) Inventors: Kenneth Jerome GOLDMAN, Palo Alto, CA (US); Rune DAHL, Mountain View, CA (US); Jeremy Scott HURWITZ, Mountain View, CA (US)

(21) Appl. No.: 13/399,817

(22) Filed: Feb. 17, 2012

(51) Int. Cl. G06F 9/46

(52) U.S. Cl. 718/100

(57) ABSTRACT

Parallel data processing may include map and reduce processes. Map processes may include at least one input thread and at least one output thread. Input threads may apply map operations to produce key/value pairs from input data blocks. These pairs may be sent to internal shuffle units which distribute the pairs, sending specific pairs to particular output threads. Output threads may include multiblock accumulators to accumulate and/or multiblock combiners to combine values associated with common keys in the key/value pairs. Output threads can output intermediate pairs of keys and combined values. Likewise, reduce processes may access intermediate key/value pairs using multiple input threads. Reduce operations may be applied to the combined values associated with each key. Reduce processes may contain internal shuffle units that distributes key/value pairs and sends specific pairs to particular output threads. These threads then produce the final output.

### BACKGROUND

Large-scale data processing may include extracting records from data blocks within data sets and processing them into key/value pairs. The implementation of large-scale data processing may include the distribution of data and computations among multiple disks and processors to make use of aggregate storage space and computing power. A parallel processing system may include one or more processing devices and one or more storage devices. Storage devices may store instructions that, when executed by the one or more processing devices, implement a set of map processes and a set of reduce processes.

### SUMMARY

This specification describes technologies relating to parallel processing of data, and specifically a system and a computer-implemented method for parallel processing of data that improves control over multithreading, consolidates map output, thereby improving data locality and reducing disk seeks, and decreases the aggregate amount of data that needs to be sent over a network and/or read from disk and processed by later stages in comparison to a conventional parallel processing system.

In general, one aspect of the subject matter described in this specification can be embodied in a method and system that includes one or more processing devices and one or more storage devices. The storage devices store instructions that, when executed by the one or more processing devices, implement a set of map processes. Each map process includes: at least one map input thread, which accesses and reads an input data block assigned to the map process, parses key/value pairs from the input data block, and applies a map operation to the key/value pairs from the input data block to produce intermediate key/value pairs; an internal shuffle unit that distributes the key/value pairs and directs individual key/value pairs to at least one specific output thread; and a plurality of map output threads to receive key/value pairs from the internal shuffle unit and write the key/value pairs as map output.

These and other embodiments can optionally include one or more of the following features. For example, the number of input threads and output threads may be configurable. The number of input threads and output threads may be configurable, but specified independently of one another. The internal shuffle unit may send a key/value pair to a specific output thread based on the key. At least one output thread may accumulate key/value pairs using a multiblock accumulator before writing map output. Output threads may optionally use multiblock combiners to combine key/value pairs before writing map output. The output threads may also use both a multiblock accumulator and a multiblock combiner before writing map output. The system may further include a set of reduce processes where each reduce process accesses at least a subset of the intermediate key/value pairs output by the map processes and apply a reduce operation to the values associated with a specific key to produce reducer output. The internal shuffle unit may send a key/value pair to a specific output thread based on an association of a specific key to an output thread which is defined based on a particular subset of the reduce processes.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating an exemplary parallel data processing system.

FIG. 2 is a block diagram illustrating an exemplary embodiment of the invention

FIG. 3 is a block diagram illustrating an exemplary map worker

FIG. 4 is a flow diagram illustrating an exemplary method for parallel processing of data using input threads, an internal shuffle unit, and multiple output threads.

FIG. 5 is a block diagram illustrating an example of a datacenter.

FIG. 6 is a block diagram illustrating an exemplary computing device.

### DETAILED DESCRIPTION

A conventional system for parallel data processing, commonly called the MapReduce model, is described in detail in MapReduce: Simplified Data Processing on Large Clusters, OSDI'04: Sixth Symposium on Operating System Design and Implementation, San Francisco, Calif., December, 2004 and U.S. Pat. No. 7,650,331 and incorporated by reference. Certain modifications to the MapReduce system are described in patent application Ser. No. 13/191, 703 for Parallel Processing of Data.

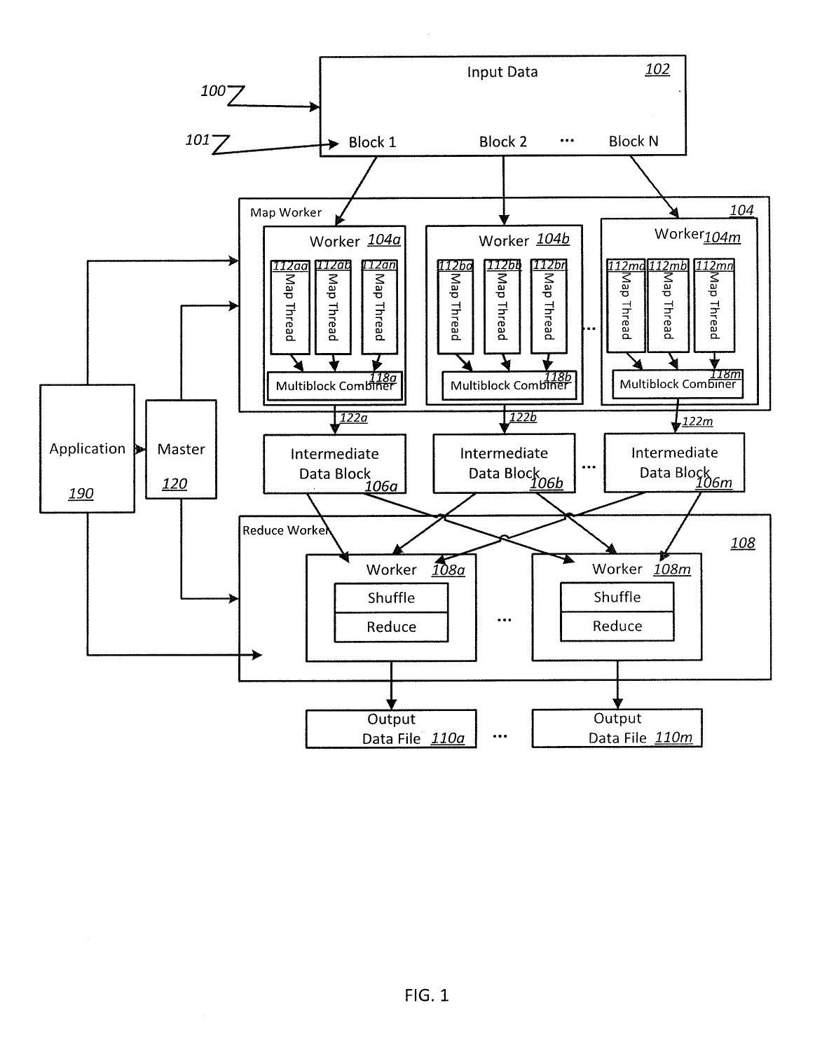

FIG. 1 illustrates an exemplary parallel data processing system. The system receives a data set as input (102), divides the data set into data blocks (101), parses the data blocks into key/value pairs, sends key/value pairs through a user-defined map function to create a set of intermediate key/value pairs (106a . . . 106m), and reduces the key/value pairs by combining values associated with the same key to produce a final value for each key.

In order to produce a final value for each key, the conventional system performs several steps. First, the system splits the data sets into input data blocks (101). The division of an input data set (102) into data blocks (101) can be handled automatically by application independent code. Alternately, the system user may specify the size of the shards into which the data sets are divided.

As illustrated in FIG. 1, the system includes a master (120) that may assign workers (104, 108) specific tasks. Workers can be assigned map tasks, for parsing and mapping key/value pairs (104a . . . 104m), and/or reduce tasks, for combining key/value pairs (108a . . . 108m). Although FIG. 1 shows certain map workers (104a . . . 104m) and certain reduce workers (108a . . . 108m), any worker can be assigned both map tasks and reduce tasks.

Workers may have one or more map threads (112aa . . . 112nm) to perform their assigned tasks. For example, a worker may be assigned multiple map tasks in parallel. A worker can assign a distinct thread to execute each map task. This map worker (104) can invoke a map thread (112aa . . . 112an) to read, parse, and apply a user-defined, application-specific map operation to a data block (101). In FIG. 1, each map worker can handle n map tasks in parallel (112an, 112bn, 112nm).

Map threads (112aa . . . 112nm) parse key/value pairs out of input data blocks (101) and pass each key/value pair to a user-defined, application-specific map operation. The map worker (104) then applies the user-defined map operation to produce zero or more intermediate key/value pairs, which are written to intermediate data blocks (106a . . . 106m)

As illustrated in FIG. 1, using a multiblock combiner (118a . . . 118m), values associated with a given key can be accumulated and/or combined across the input data blocks processed by the input threads (112aa . . . 112nm) of a specific map worker (104) before the map worker outputs key/value pairs.

The intermediate data blocks produced by the map workers (104) are buffered in memory within the multiblock combiner and periodically written to intermediate data blocks on disk (106a . . . 106m). The master is passed the locations of metadata, which in turn contains the locations of the intermediate data blocks. The metadata is also directly forwarded from the map workers to the reduce workers (108). If a map worker fails to send the location metadata, the master tasks a different map worker with sending the metadata and provides that map worker with the information on how to find the metadata.

When a reduce worker (108) is notified about the locations of the intermediate data blocks, the reduce worker (108) shuffles the data blocks (106a . . . 106m) from the local disks of the map workers. Shuffling is the act of reading the intermediate key/value pairs from the data blocks into a large buffer, sorting the buffer by key, and writing the buffer to a file. The reduce worker (108) then does a merge sort of all the sorted files at once to present the key/value pairs ordered by key to the user-defined, application-specific reduce function.

After sorting, the reduce worker (108) iterates over the sorted intermediate key/value pairs. For each unique intermediate key encountered, the reduce worker (108) passes the key and an iterator, which provides access to the sequence of all values associated with the given key, to the user-defined reduce function. The output of the reduce function is written to a final output file. After successful completion, the output of the parallel processing of data system is available in the output data files (110), with one file per reduce task.

A conventional system may be used to count the number of occurrences of each word in a large collection of documents. The system may take the collection of documents as the input data set. The system may divide the collection of documents into data blocks. A user could write a map function that can be applied to each of the records within a particular data block in order for a set of intermediate key/value pairs to be computed from the data block. The map function could be represented as: map (String key, String value)

The function may take in a document name as a key and the document's contents as the value.

This function can recognize a specific word in the document's contents. For each word, w, in the document's contents, the function could produce the word count, l, and output the key/value pair (w, l).

The map function may be defined as follows:

map(String key, String value)
//key: document name
//value: document’s contents
for each word w in value:
EmitIntermediate(w, 1);

A map worker can process several input data blocks at the same time using multiple input threads. Once the map worker's input threads parse key/value pairs from the input data blocks, the map worker can accumulate and/or combine values associated with a given key across the input data blocks processed by the map worker's input threads. A user could write a combine function that combines some of the word counts produced by the map function into larger values to reduce the amount of data that needs to be transferred during shuffling and the number of values that need to be processed by the reduce process.

A multiblock combiner may be used to combine map output streams from multiple map threads within a map process. For example, the output from one input thread (112a) could be (“you, 1”), (“know, 1”), and (“you, 1”). A second input thread (112b) could have the output, (“could, 1”), and a third input thread (112c) could produce (“know, 1”) as output. The multiblock combiner can combine the outputs from these three threads to produce the output: (“could, 1”), (“you, 2”), and (“know, 2”).

The combine function may be defined as follows:

```
Combine(String key, Iterator values):
//key: a word
//values: a list of counts
int result = 0;
  for each v in values:
    result += ParseInt(v);
Emit (key, AsString(result));
```

The key/value pairs produced by the map workers are called intermediate key/value pairs because the key/value pairs are not yet reduced. These key/value pairs are grouped together according to distinct key by a reduce worker's (108) shuffle process. This shuffle process takes the key/value pairs produced by the map workers and groups together all the key/value pairs with the same key. The shuffle process then produces a distinct key and a stream of all the values associated with that key for the reduce function to use.

In the word count example, the reduce function could sum together all word counts emitted from map workers for a particular word and output the total word count per word for the entire collection of documents.

The reduce function may be defined as follows:

```
  reduce (String key, Iterator values):
//key: a word
//values: a list of counts
int result = 0;
  for each v in values:
    result += ParseInt(v);
Emit (key, AsString(result));
```

After successful completion, the total word count per word per document for the entire collection of documents is written to a final output file (110) with one file per reduce task.

A noticeable problem with the conventional system is that the accumulation, combination, and production of output for an entire collection of data blocks processed by a map worker is normally accomplished with a single output thread (122a). Having only one output thread is a bottleneck for applications with large amounts of map worker output because it limits parallelism in the combining step as well as the output bandwidth.

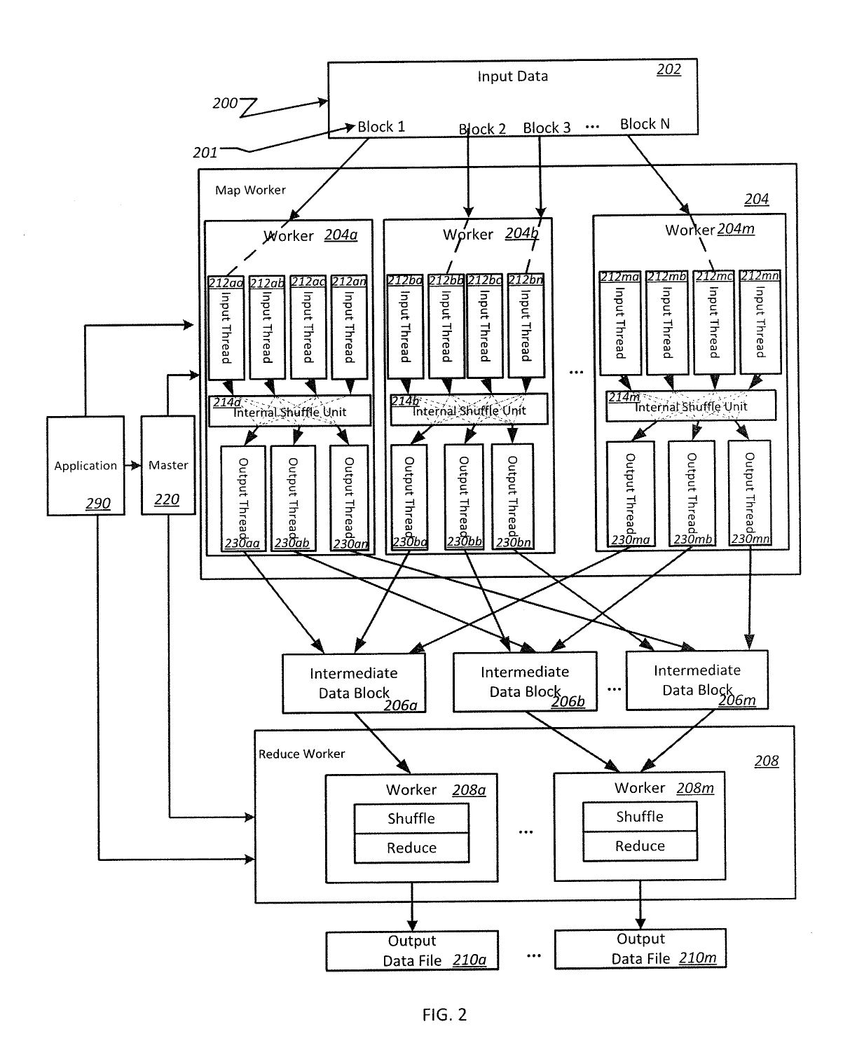

In an exemplary embodiment as illustrated by FIG. 2, a map worker (204) can be constructed to include multiple output threads, which allow for accumulating and combining across multiple input data blocks. In order to have multiple output threads that can accumulate and combine, the map worker (204) should also include an internal shuffle unit (214), which is described below.

In some instances, as shown in FIG. 2, the map worker (204) may access one or more input data blocks (201) partitioned from the input data set (202) and may perform map tasks for each of the input data blocks. FIG. 2 illustrates that, in an exemplary embodiment, data blocks can either be processed by a single input thread one data block at a time, or some or all of the data blocks can be processed by different input threads in parallel. In order to process data blocks in parallel, the map worker (204) can have multiple input threads (212) with each map input thread (212) performing map tasks for one or more input data blocks (201).

The number of map input and output threads can be specified independently. For example, an application (290) that does not support concurrent mapping in a single worker can set the number of input threads to 1, but still take advantage of multiple output threads. Similarly, an application (290) that does not support concurrent combining can set the number of output threads to 1, but still take advantage of multiple input threads.

As discussed above, a map worker input thread (212) can parse key/value pairs from input data blocks and pass each key/value pair to a user-defined, application-specific map operation. The user-defined map operation can produce zero or more key/value pairs from the records in the input data blocks.

The key/value pairs produced by the user-defined map operation can be sent to an internal shuffle unit (214). The internal shuffle unit (214) can distribute the key/value pairs across multiple output threads (230), sending each key/value pair to a particular output thread destination based on its key.

As illustrated in FIG. 2, each map worker should have more than one output thread to provide for parallel computing and prevent bottlenecks in applications with large amounts of map output. With multiple output threads, the map worker can produce output in parallel which improves performance for Input/Output bound jobs, particularly when a large amount of data must be flushed at the end of a collection of data blocks processed as a larger unit. The output threads (230aa . . . 230nm) will output the intermediate key/value pairs to intermediate data blocks (206a . . . 206m). Each output thread typically writes to a subset of the intermediate data blocks, so shuffler processes consume larger reads from fewer map output sources. As a result, the output from the map worker is less fragmented, leading to more efficient shuffling than would be achieved if each output thread produced output for each data block. This benefit occurs even if there is no accumulator or combiner, and, due to the internal shuffle unit, in spite of potentially having many parallel output threads per map worker.

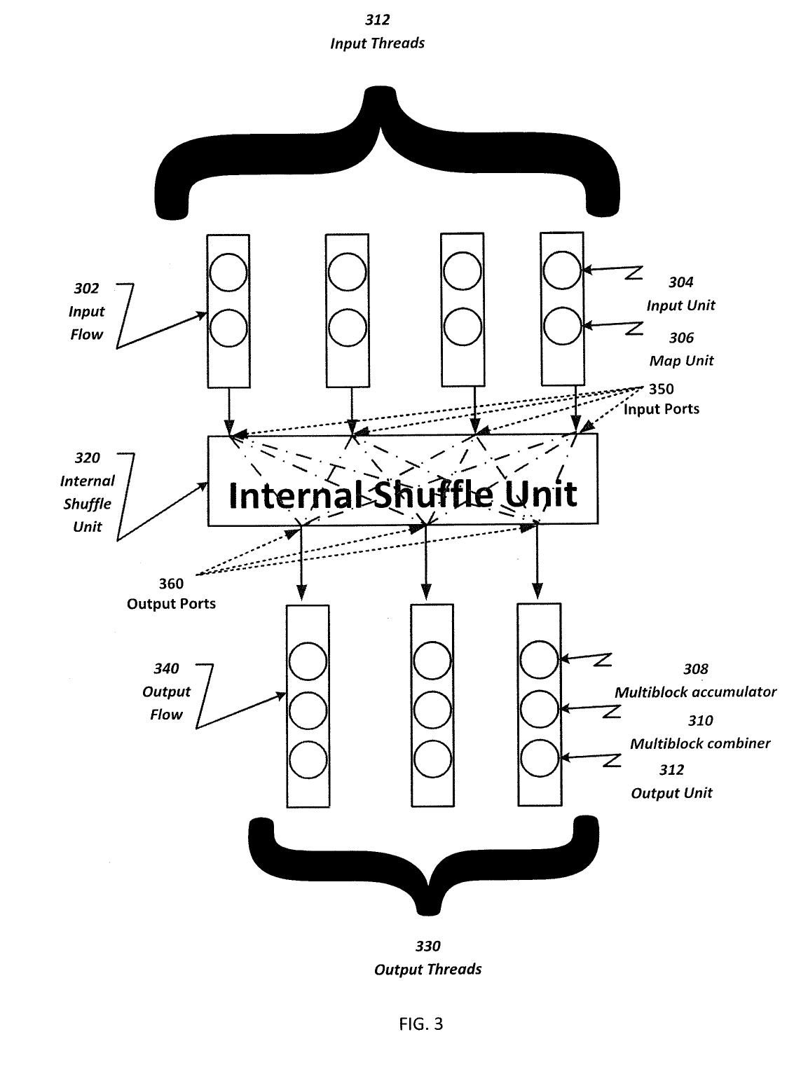

FIG. 3 shows that, in some instances, each input thread (312) can execute an input flow (302) that consumes input and produces output. An input flow (302) can have multiple flow processes to input (read) (304) and map (306) input data blocks into key/value pairs using a user-defined, application-specific map operation. The input flow (302) then passes the key/value pairs through an internal shuffle unit (320) to output threads (330).

The map worker's internal shuffle unit should have a set of input ports (350), one per input thread, and a set of output ports (360), one per output thread. The input ports (350) contain buffers to which only the input threads write. The output ports contain buffers that are only read by the output threads.

The job of the internal shuffle unit (320) is to move the key/value pairs from the input ports (350) to the appropriate output ports (360). In a simple implementation, the internal shuffle unit (320) could send each incoming key/value pair to the appropriate output port immediately. However, this implementation may result in lock contention.

In other implementations, each input port to the internal shuffle unit (320) has a buffer and only moves key/value pairs to an output port when a large number of key/value pairs have been buffered. This move is done in such a way as to avoid, if possible, the input buffer from filling completely and to avoid, if possible, the output buffer from emptying completely, since either condition would block the corresponding input or output thread. The buffer/move process happens repeatedly for each input port and output port until all input data has been consumed by the input thread, at which point all buffered data is flushed to the output threads.

Each unique key is shuffled to exactly one reduce task, which is responsible for taking all of the values for that key from different map output blocks from all map workers and producing a final value. The internal shuffle unit consistently routes each key/value pair produced by an input thread to one particular output thread based on its key. This routing ensures that each output thread produces key/value pairs for a particular, non-overlapping, subset of the reduce processes. In some instances, the internal shuffle unit (320) uses modulus-based indexing to choose the appropriate output port in which to send key/value pairs. For example, if there are two (2) output threads, the internal shuffle unit might send all key/value pairs corresponding to even-numbered reduce tasks to thread 1 and all key/value pairs corresponding to odd-numbered reduce tasks to thread 2. This modulus-based indexing ensures that all values for a given key are put in the same output thread for maximum combining.

In other instances, the appropriate output port is chosen by taking into account load-balancing and/or application-specific features.

Each output thread (330) is responsible for an output flow (340), which can optionally accumulate (308) and/or combine (310) the intermediate key/value pairs before buffering the key/value pairs in the output unit (312) and writing data blocks containing these pairs to disk.

Instead of holding the key/value pairs produced by the map input threads individually in memory prior to combining via a multiblock combiner, a multiblock accumulator (308) may be associated with each output thread (330). The multiblock accumulator can accumulate key/value pairs. It can also update the values associated with any key and even create new keys. The multiblock accumulator maintains a running tally of key/value pairs, updating the appropriate state as each key/value pair arrives. For example, in the word count application discussed above, the multiblock accumulator can increase a count value associated with a key as it receives new key/value pairs for that key. The multiblock accumulator could keep the count of word occurrences and also keep a list of the ten (10) longest words seen. If all keys can be held in memory, the multiblock accumulator may hold all of the keys and accumulated values in memory until all of the input data blocks have been processed, at which time the multiblock accumulator may output the key/value pairs to be shuffled and sent to reducers, or optionally to a multiblock combiner for further combining before being shuffled and reduced. If all key/value pairs do not fit in the memory of the multiblock accumulator, the multiblock accumulator may periodically flush its key/value pairs as map output, to a multiblock combiner or directly to be shuffled.

In addition to a multiblock accumulator, each output thread may contain a multiblock combiner (310). Although a multiblock combiner in the conventional system could accumulate and combine, the multiblock combiner in the exemplary system only combines values associated with a given key across the input data blocks processed by the input threads (312) of a specific map worker. By using a multiblock combiner to group key values, a map worker can decrease the amount of data that has to be shuffled and reduced by a reduce worker.

In some implementations, the multiblock combiner, (310) buffers intermediate key/value pairs, which are then grouped by key and partially combined by a combine function. The partial combining performed by the multiblock combiner may speed up certain classes of parallel data processing operations, in part by significantly reducing the amount of information to be conveyed from the map workers to the reduce workers, and in part by reducing the complexity and computation time required by the data sorting and reduce functions performed by the reduce tasks.

In other implementations, the multiblock combiner (310) may produce output on the fly as it receives input from the internal shuffle unit. For example, the multiblock combiner can include memory management functionality for generating output as memory is consumed. The multiblock combiner may produce output after processing one or more of the key/value pairs from the internal shuffle unit or upon receiving a Flush( ) command for committing data in memory to storage. By combining values for duplicate keys across multiple input data blocks, the multiblock combiner can generate intermediate data blocks, which may be more compact than blocks generated by a combiner that only combines values for a single output block. In general, the intermediate data block includes key/value pairs produced by the multiblock combiner after processing multiple input data blocks together.

For example, when multiple input data blocks include common keys, the intermediate key/value pairs produced by a map worker's map threads (312) can be grouped together by keys using the map worker's multiblock combiner (310). Therefore, the intermediate key/value pairs do not have to be sent to the reduce workers separately.

In some cases, such as when the multiblock combiner (310) can hold key/value pairs in memory until the entire input data blocks are processed, the multiblock combiner may generate pairs of keys and combined values after all blocks in the set of input data blocks are processed. For example, upon receiving key/value pairs from a map thread for one of the input data blocks, the multiblock combiner may maintain the pairs in memory or storage until receiving key/value pairs for the remaining input data blocks. In some implementations, the keys and combined values can be maintained in a hash table or vector. After receiving key/value pairs for all of the input data blocks, the multiblock combiner may apply combining operations on the key/value pairs to produce a set of keys, each with associated combined values.

For example, in the word count application discussed above, the multiblock combiner produce a combined count associated with each key. Generally, maximum combining may be achieved if the multiblock combiner can hold all keys and combined values in memory until all input data blocks are processed.

However, the multiblock combiner may produce output at other times by flushing periodically due to memory limitations. In some implementations, upon receiving a Flush( ) call, the multiblock combiner may iterate over the keys in a memory data structure, and may produce a combined key/value pair for each key. In some cases, the multiblock combiner may choose to flush different keys at different times, based on key properties such as size or frequency. For example, only rare keys may be flushed when the memory data structure becomes large, while more common keys may be kept in memory until a final Flush( ) command.

The key/value pairs produced after the multiblock accumulator and/or multiblock combiner executes are then buffered in memory and periodically written to intermediate data blocks on disk as depicted in FIG. 2 (206a . . . 206m).

Map workers, accumulators, and combiners do not need to be prepared to accept concurrent calls from multiple threads. Each input thread (312) has its own map unit (306) and each output thread (330) may have its own multiblock accumulator (308) and/or multiblock combiner (310).

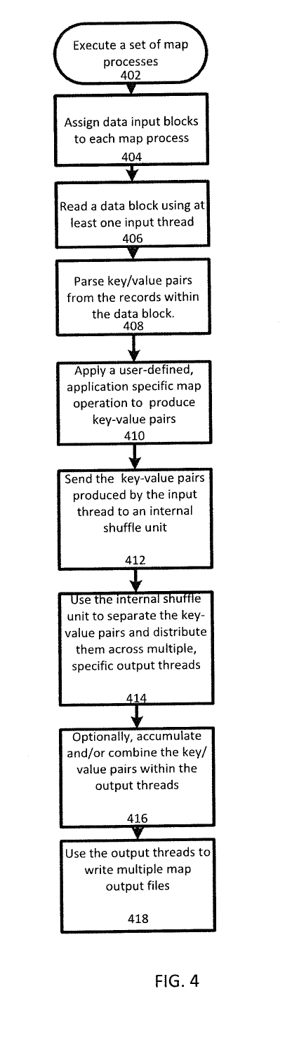

FIG. 4 illustrates an exemplary method for parallel processing of data according to aspects of the inventive concepts. The method begins with executing a set of map processes (402). Data input blocks are assigned to each map process (404). A data block is read by at least one input thread of the map process (406). Key/value pairs are parsed from the records within a data block (408). A user-defined, application-specific map operation is then applied to key/value pairs to produce intermediate key/value pairs from the input thread (410). The intermediate key/value pairs produced by the input thread are sent to an internal shuffle unit (412). Using the internal shuffle unit, the key/value pairs are distributed across multiple output threads with individual key/value pairs being sent to specific output threads (414). Within the output threads, the key/value pairs can be optionally accumulated and/or combined (416). Multiblock accumulators can be used to perform the accumulating. Multiblock combiners may do the combining. Finally, multiple map output files are written from the key/value pairs produced by the multiple output threads (418). The exemplary method can use the shuffle/reduce process discussed in the conventional system to further process and reduce data.

Although an exemplary embodiment defines a map worker that has multiple input threads, an internal shuffle unit, and multiple output threads, any worker in this parallel data processing system, including reduce workers, can have multiple input threads, an internal shuffle unit, and multiple output threads.

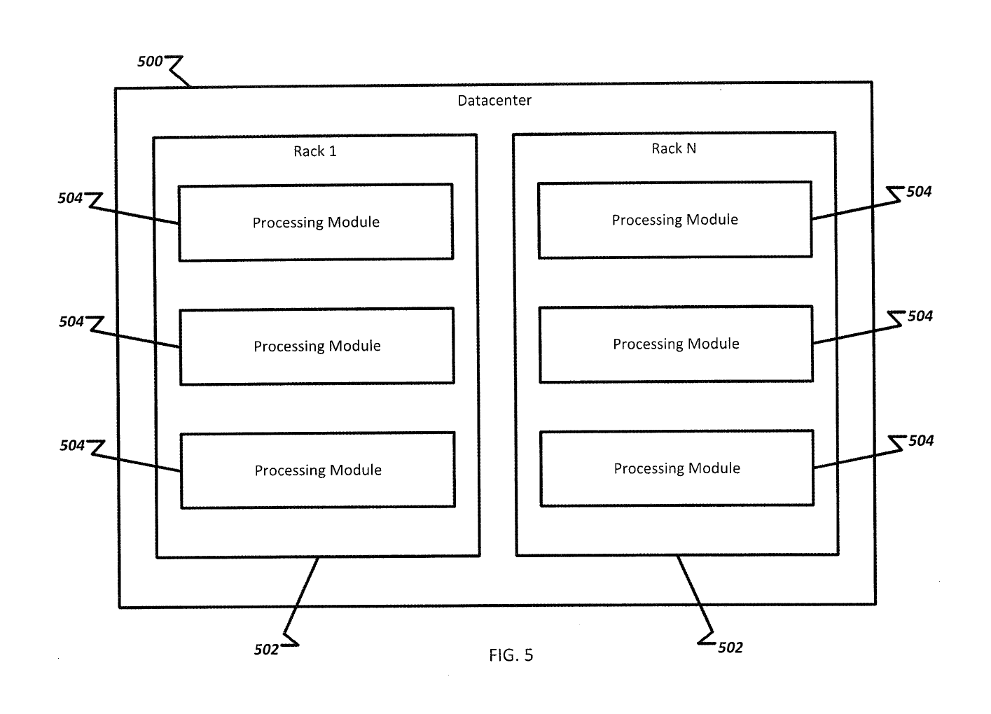

FIG. 5 is a block diagram illustrating an example of a datacenter (500). The data center (500) is used to store data, perform computational tasks, and transmit data to other systems outside of the datacenter using, for example, a network connected to the datacenter. In particular, the datacenter (500) may perform large-scale data processing on massive amounts of data.

The datacenter (500) includes multiple racks (502). While only two racks are shown, the datacenter (500) may have many more racks. Each rack (502) can include a frame or cabinet into which components, such as processing modules (504), are mounted. In general, each processing module (504) can include a circuit board, such as a motherboard, on which a variety of computer-related components are mounted to perform data processing. The processing modules (504) within each rack (502) are interconnected to one another through, for example, a rack switch, and the racks (502) within each datacenter (500) are also interconnected through, for example, a datacenter switch.

In some implementations, the processing modules (504) may each take on a role as a master or worker. The master modules control scheduling and data distribution tasks among themselves and the workers. A rack can include storage, like one or more network attached disks, that is shared by the one or more processing modules (504) and/or each processing module (504) may include its own storage. Additionally, or alternatively, there may be remote storage connected to the racks through a network.

The datacenter (500) may include dedicated optical links or other dedicated communication channels, as well as supporting hardware, such as modems, bridges, routers, switches, wireless antennas and towers. The datacenter (500) may include one or more wide area networks (WANs) as well as multiple local area networks (LANs).

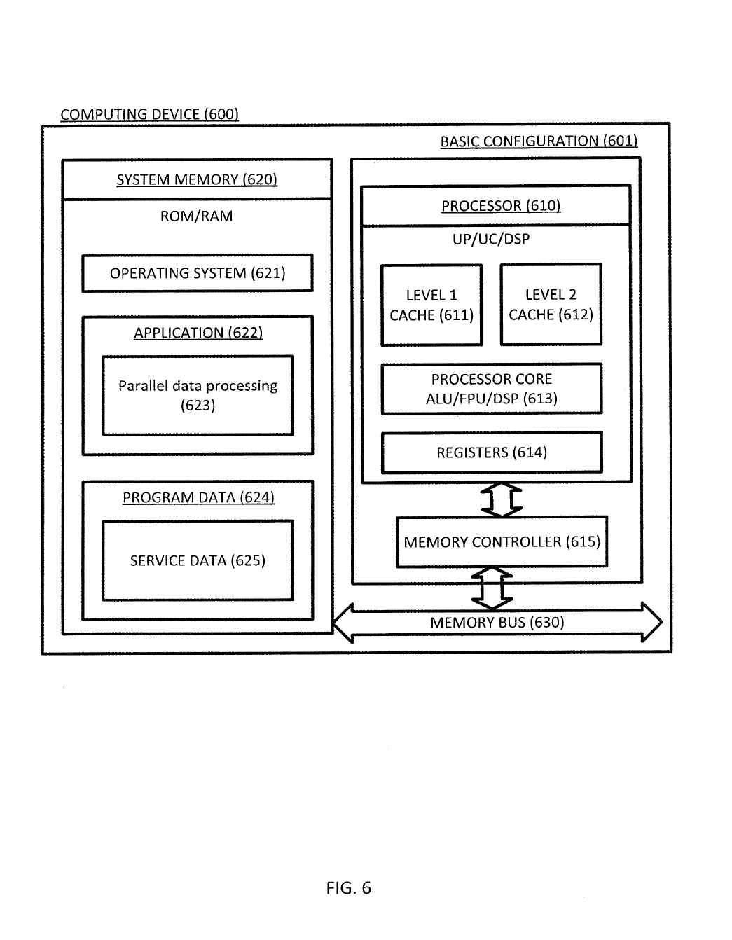

FIG. 6 is a block diagram illustrating an example computing device (600) that is arranged for parallel processing of data and may be used for one or more of the processing modules (504). In a very basic configuration (601), the computing device (600) typically includes one or more processors (610) and system memory (620). A memory bus (630) can be used for communicating between the processor (610) and the system memory (620).

Depending on the desired configuration, the processor (610) can be of any type including but not limited to a microprocessor (μP), a microcontroller (μC), a digital signal processor (DSP), or any combination thereof. The processor (610) can include one more levels of caching, such as a level one cache (611) and a level two cache (612), a processor core (613), and registers (614). The processor core (613) can include an arithmetic logic unit (ALU), a floating point unit (FPU), a digital signal processing core (DSP Core), or any combination thereof. A memory controller (616) can also be used with the processor (610), or in some implementations the memory controller (615) can be an internal part of the processor (610).

Depending on the desired configuration, the system memory (620) can be of any type including but not limited to volatile memory (604) (such as RAM), non-volatile memory (603) (such as ROM, flash memory, etc.) or any combination thereof. System memory (620) typically includes an operating system (621), one or more applications (622), and program data (624). The application (622) includes an application that can perform large-scale data processing using parallel processing. Program Data (624) includes storing instructions that, when executed by the one or more processing devices, implement a set of map processes and a set of reduce processes. In some embodiments, the application (622) can be arranged to operate with program data (624) on an operating system (621).

The computing device (600) can have additional features or functionality, and additional interfaces to facilitate communications between the basic configuration (601) and any required devices and interfaces. For example, a bus/interface controller (640) can be used to facilitate communications between the basic configuration (601) and one or more data storage devices (650) via a storage interface bus (641). The data storage devices (650) can be removable storage devices (651), non-removable storage devices (652), or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory (620), removable storage (651), and non-removable storage (652) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of the device (600).

The computing device (600) can be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device (600) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for parallel processing of data, the system comprising:
one or more processing devices;
one or more storage devices storing instructions that, when executed by the one or more processing devices, cause the one or more processing devices to implement:
a set of map processes, each map process including:
at least one map input thread accessing an input data block assigned to the map process;
the map input thread reading and parsing key/value pairs from the input data block;
the map input thread applying a map operation to the key/value pairs from the input data block to produce intermediate key/value pairs;
an internal shuffle unit that distributes the key/value pairs and directs individual key/value pairs to at least one specific output thread; and
a plurality of map output threads to receive key/value pairs from the internal shuffle unit and write the key/value pairs as map output.

2. The system of claim 1, wherein the number of input threads and output threads is configurable.

3. The system of claim 2, wherein the number of input and output threads is configurable, but specified independently of one another.

4. The system of claim 1, wherein the internal shuffle unit sends a key/value pair to a specific output thread based on the key.

5. The system of claim 1, wherein at least one output thread accumulates key/value pairs using a multiblock accumulator before writing map output.

6. The system of claim 1, wherein at least one output thread combines key/value pairs using a multiblock combiner before writing map output.

7. The system of claim 1, wherein at least one output thread both accumulates and combines key/value pairs using a multiblock accumulator and a multiblock combiner before writing map output.

8. The system of claim 1, further comprising a set of reduce processes, each reduce process accessing at least a subset of the intermediate key/value pairs output by the map processes and applying a reduce operation to the values associated with a specific key to produce reducer output.

9. The system of claim 8, wherein the association of a specific key to an output thread is defined based on a particular subset of the reduce processes.

10. A computer-implemented method for parallel processing of data comprising:
executing a set of map processes on one or more interconnected processing devices;
assigning one or more input data blocks to each of the map processes;
in at least one map process, using at least one input thread to read an input data block;
using the input thread to apply a map operation to records in the data block to produce key/value pairs;
shuffling key/value pairs produced by the input thread to direct an individual key/value pair to a specific output thread; and
using the output thread to write key/value pairs as map output.

11. The computer-implemented method of claim 10, wherein the number of input threads and output threads is configurable.

12. The computer-implemented method of claim 11, wherein the number of input and output threads is configurable, but specified independently of one another.

13. The computer-implemented method of claim 10, wherein the internal shuffle unit sends key/value pairs to output threads based on the key and consistently routes a specific key to a particular output thread.

14. The computer-implemented method of claim 10, wherein the output thread accumulates key/value pairs using a multiblock accumulator before writing map output.

15. The computer-implemented method of claim 10, wherein the output thread combines key/value pairs using a multiblock combiner before writing map output.

16. The computer-implemented method of claim 10, wherein the output thread both accumulates and combines key/value pairs using a multiblock accumulator and a multiblock combiner before writing map output.

17. The computer-implemented method of claim 10, further comprising:
executing a set of reduce processes on one or more interconnected processing devices; each reduce process accessing at least a subset of the intermediate key/value pairs output by the map processes and applying a reduce operation to the values associated with a specific key to produce reducer output.

18. The system of claim 17, wherein the association of a specific key to an output thread is defined based on a particular subset of the reduce processes.
